(19) United States
(12) Patent Application Publication
(10) Pub. No.: US 2006/0174244 A1
(43) Pub. Date: Aug. 3, 2006

(54) System and method for modifying execution flow in firmware

(76) Inventors: Paul R. Woods, Corvallis, OR (US); Donald M. Reid, Corvallis, OR (US)

Correspondence Address: AVAGO TECHNOLOGIES, LTD., P.O. BOX 1920, DENVER, CO, 80201-1920, US

(21) Appl. No.: 11/047,298

(22) Filed: Jan. 31, 2005

(51) Int. Cl. G06F 9/445

(52) U.S. Cl. 717/174

(57) ABSTRACT

A system and method for enabling control transfer in firmware through content addressable memory (CAM) and related circuitry. The system includes, but is not limited to, firmware having at least one target executable instruction, a CAM that can assert a match when the target executable instruction is attained, and circuitry capable of either indicating the target executable instruction to patch handler or forming an opcode by concatenating an opcode template with at least one bit of the control flow transfer address. Execution control is transferred form a firmware instruction preceding the target executable instruction either from a control transfer opcode to a patch handler and then to patch code, or through the opcode directly to patch code, if the CAM asserts a match and if an enable bit is set.

### BACKGROUND OF THE INVENTION

Using mask-programmed read only memory (ROM) to store firmware in an embedded system has the disadvantage that the code cannot be changed without creating a new revision of the chip, an expensive and time-consuming process because a new batch of chips must be produced. Currently, a technique called “patching” is used that allows code execution to divert from ROM to random access memory (RAM) and then back again. At “patch points” in the ROM code are lines of code that test a bit of a word in RAM and, if that bit is set, jump to another location in RAM known as a vector table. The vector table dedicates one word for each patch point to redirect execution flow to the actual patch code that is usually stored elsewhere in RAM. Alternatively, a content addressable Memory (CAM) can be used to match ROM addresses to be patched and redirect execution flow accordingly. These techniques require external access to RAM via a serial interface so that (1) a patch can be written into RAM, (2) the patch can be enabled by writing a jump instruction into the appropriate vector table location, and (3) the patch enable bit can be set indicating that execution control is to be transferred.

A disadvantage of the current RAM-based technique is that if some part of ROM needs to be patched that is not close to an existing patch point, more RAM is consumed because of the need to duplicate the ROM code that sits between the patch point and the target of the patch. More patch points can be added, but each patch point requires two ROM words, a RAM word, and a RAM bit. A further disadvantage is that if the patch points themselves are defective (for example, if patch points are unintentionally duplicated), they may be rendered useless or more difficult to use. A disadvantage of the current CAM-based technique is the need for several redirections before the actual patch code is executed.

A system and method are needed that allow flexible code patching that can be accomplished without substantial resource requirements.

### SUMMARY OF THE INVENTION

The problems set forth above as well as further and other problems are resolved by the present invention. The solutions and advantages of the present invention are achieved by the illustrative embodiments and methods described herein below.

The system and method of the present invention enable modifying execution control transfer (also referred to as patching) in firmware through a CAM and other related circuitry. The system can include, but is not limited to, firmware having at least one target executable instruction, a CAM that can assert a match when the program counter attains the target executable instruction, and circuitry capable of either providing a way for a patch handler to determine the location of the target executable instruction, or circuitry capable of forming an opcode by concatenating an opcode template with at least one bit of a CAM matching address. In the system of the present invention, execution control is transferred from a firmware instruction preceding the target executable instruction through the either a vector or the opcode to either the patch handler or the patch code if the CAM asserts a match and if an enable bit is set indicating that a patch is to be inserted at the target executable instruction. If execution control is transferred to the patch handler, the patch handler determines the location of the target executable instruction and transfers control to the patch code based on that determination. The system can optionally include a method, such as a serial interface, to load the contents of the CAM, the opcode template or vector, and the enable bit, where the method can operate without the involvement of the Central Processing Unit (CPU).

The method of the present invention can include, but is not limited to, the steps of loading a CAM with at least one address corresponding to at least one target executable instruction in firmware, loading a vector with an execution transfer opcode or an opcode template, executing firmware instructions until at least one target executable instruction is attained, testing an enable bit indicating that execution control is to be transferred, either transferring execution control to a patch handler via the vector or combining the opcode template with a subset of the matching address in the CAM to create an opcode if a match is asserted in the CAM and if the enable bit is set, and transferring execution control to either a patch handler or patch code through the execution of either the vector or CAM opcode. If control is transferred through to the patch handler, the method can also include the steps of determining the target executable instruction and transferring control to the patch code associated with the target executable instruction. The method can optionally include the step of loading the CAM, the enable bit, and the opcode template by a serial interface.

For a better understanding of the present invention, reference is made to the accompanying drawings and detailed description. The scope of the present invention is pointed out in the appended claims.

### DESCRIPTION OF THE SEVERAL VIEWS OF THE DRAWING

FIG. 1 (PRIOR ART) is a memory map of a current firmware patching technique;

FIG. 2 (PRIOR ART) is a data flow diagram illustrating the use of CAM and RAM to patch firmware;

FIG. 3 is a data flow diagram of a first embodiment of the present invention in which the use of CAM to patch firmware is enhanced with procedures and circuitry;

FIG. 4 is a data flow diagram of a second embodiment of the present invention;

FIG. 5 is a flowchart of the method of the first embodiment of the present invention; and

FIG. 6 is a flowchart of the method of the second embodiment of the present invention.

### DETAILED DESCRIPTION OF THE INVENTION

The present invention is now described more fully hereinafter with reference to the accompanying views of the drawing, in which the illustrative embodiments of the present invention are shown.

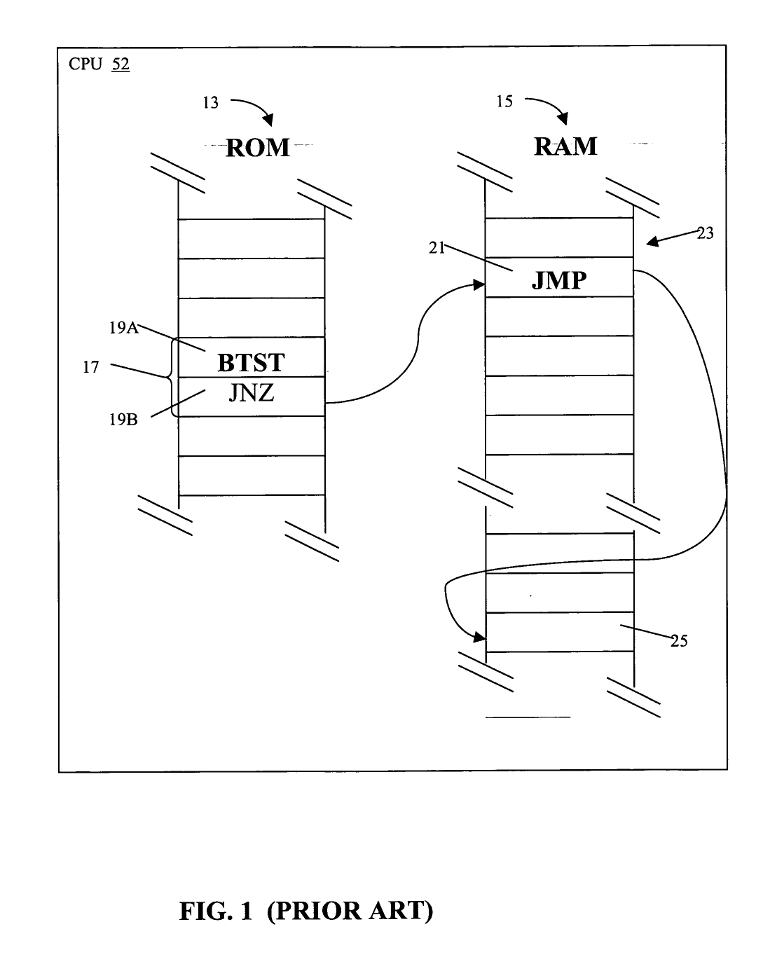

As stated above, the system and method of the present invention enable modifying execution control transfer in firmware 13 through a CAM and other related circuitry. Referring now to FIG. 1 (PRIOR ART), in systems of the prior art, to modify ROM firmware 13 code, patch point 17 is embedded in ROM firmware 13 code, and contains redirect instructions such as a bit test (BTST) 19A and jump-not-zero (JNZ) 19B. Bit test 19A tests a pre-determined bit in RAM 15 and, if that bit is set, JNZ 19B redirects execution flow to vector table 3 in RAM 15, specifically to the memory location that is dedicated to patch point 17. At that memory location is another execution flow redirect instruction, for example, jump (JMP) 21, that transfers execution flow through vector table 23 to patch handler 25 which contains the code that is to be executed at the location of patch point 17. Clearly there are several execution flow transfers in this scenario that could be consolidated.

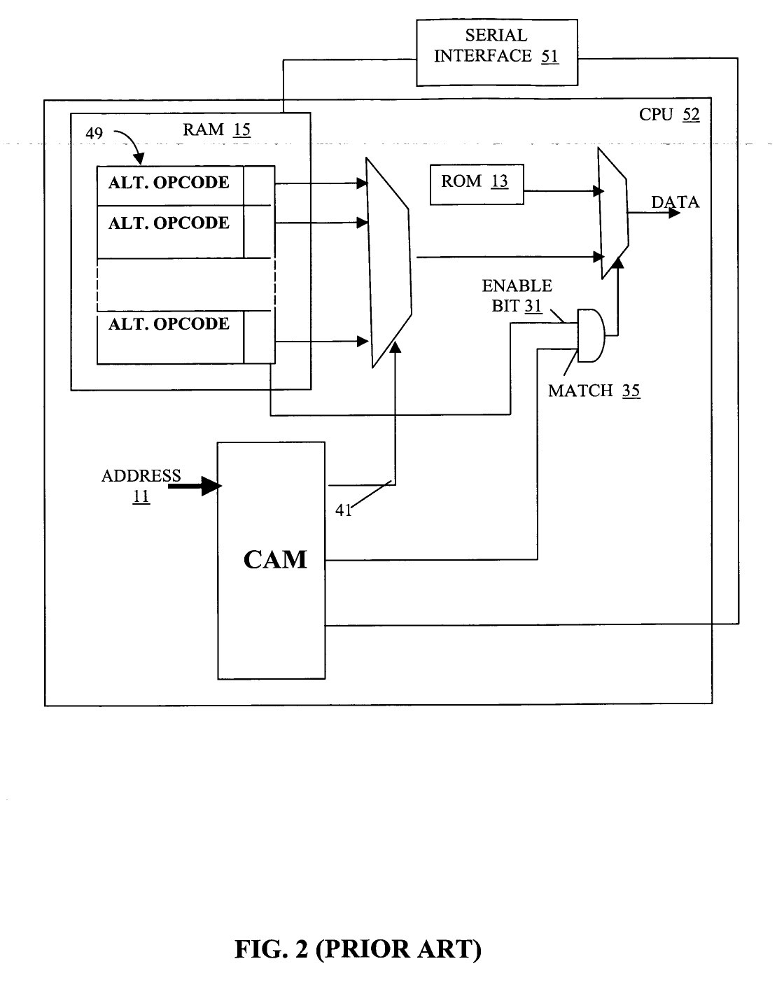

Referring now to FIG. 2 (PRIOR ART), in another system of the prior art, CAM 39 can be used to match ROM firmware 13 addresses to be patched and redirect execution flow accordingly. In the system shown in FIG. 2, addresses 11 go to ROM firmware 13 and CAM 39 substantially simultaneously. Certain locations in CAM 39 are loaded with addresses of points in ROM firmware 13 at which the code needs to be modified. An alternate opcode 49, stored, for example, in RAM 15, can be associated with each CAM 39 address. Alternate opcode 49 could allow the changing of individual words of code without changing the flow of the program. For example, one opcode could be replaced by a no operation (NOP), or a load-constant opcode could be replaced such that a different constant would be loaded. The specification of an opcode in RAM 15 and the use of CAM 39 can obviate the need for specific patch points, but RAM 15 or an equivalent alternative memory is necessary. When an incoming address 11 matches an entry in CAM 39, CAM 39 asserts match 35. If an appropriate at least one enable bit 31 is set indicating that execution control is to be transferred, the logical AND of the appropriate at least one enable bit 31 and match 35 blocks data from ROM firmware 13, and allows alternate opcode 49 to be executed as the next opcode, versus the opcode in ROM firmware 13 at the matched address. The terminology “enable bit” can refer to any variable that performs the function of designating that a patch is to be executed for a particular target executable instruction. The at least one enable bit (31) is not limited in size to one bit. Alternate opcode 49 could redirect execution flow to patch handler 25 (FIG. 1). When there is no match 35, data from ROM firmware 13 are emitted, which is the normal case when the code isn't to be patched. This technique requires external access to RAM 15 and CAM 39 via, for example, serial interface 51, so that (1) patch handler 25 and alternate opcode 49 can be loaded into RAM 15, (2) the appropriate at least one enable bit 31 can be set, and (3) CAM 39 can be loaded with patch addresses.

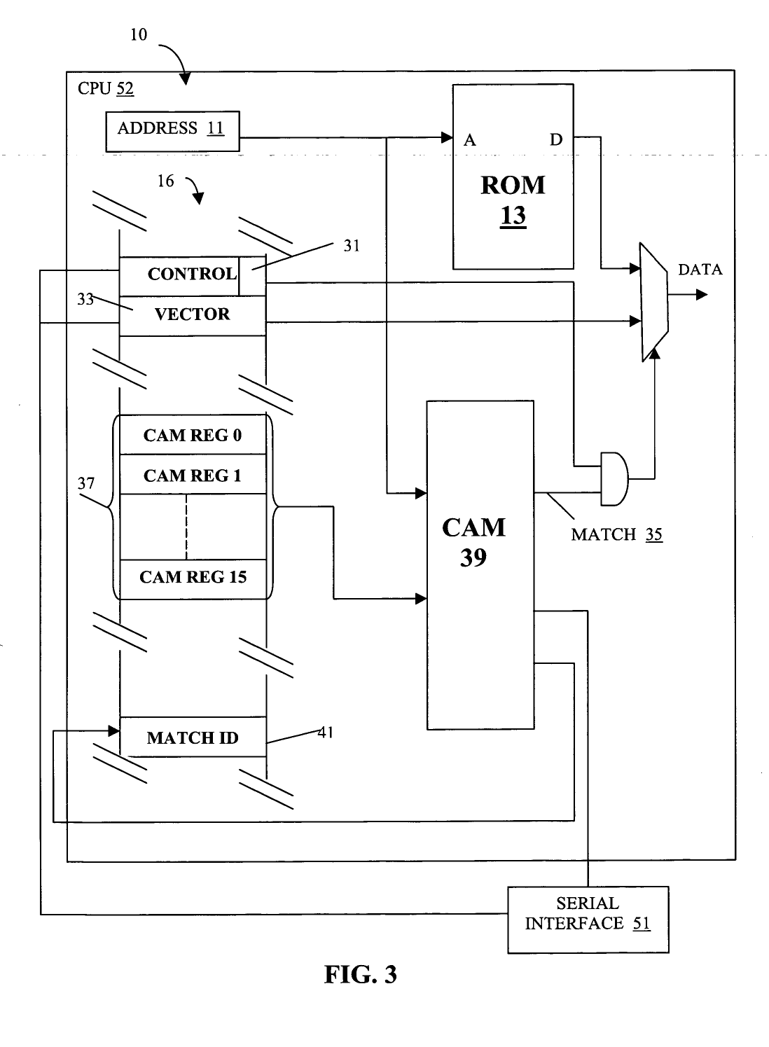

Referring now to FIG. 3, system 10 of the present invention, which overcomes the problems of the prior art, can include, but is not limited to, ROM firmware 13, CAM 39, and computer registers 16. including at least one CAM register 37. In system 10, as in the prior art, addresses 11 go to ROM firmware 13 and CAM 39 substantially simultaneously. Also, as before, locations in CAM 39, at least one CAM register 37, are loaded with addresses of points in ROM firmware 13 at which the code needs to be modified. However, in system 10, alternate opcode 49 (FIG. 2) stored in RAM 15 is replaced by vector 33 which can be, for example, a register. When an address 11 matches an entry in CAM 39, CAM 39 asserts match 35, and places the address of match 35 in match identification 41, which can be, for example, a register. When there is no match 35, data from ROM firmware 13 are emitted, which is the normal case when the code isn't patched. When match 35 is asserted, the normal data word from ROM firmware 13 is blocked and the value of vector 33 is emitted. The value of vector 33 is an opcode to jump to the location of patch handler 25 (FIG. 1). Patch handler 25 can read match identification 41 to determine which patch address matches the entry in CAM 39. With that information, patch handler 25 can jump to the location of the appropriate patch code. To enable execution flow redirection or executable code replacement in this way, CAM 39, computer registers 16, and the appropriate at least one enable bit 31 are initialized without the involvement of CPU 52 through serial interface 51, for example.

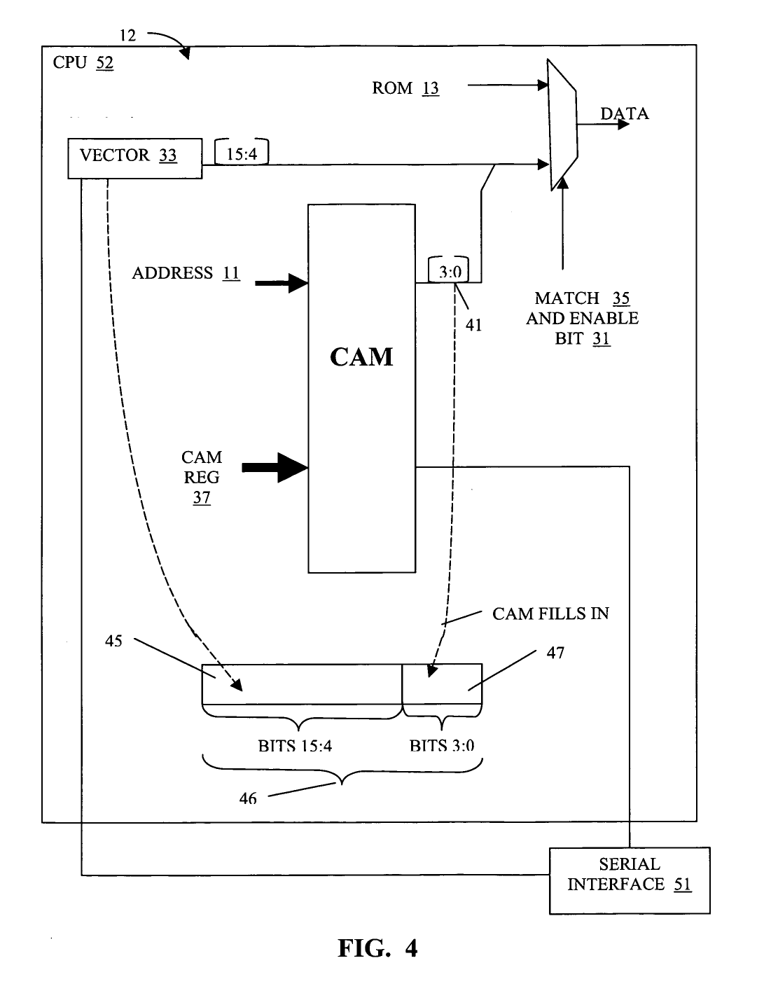

Referring now to FIG. 4, system 12, an alternative to system 10 (FIG. 3), includes, but is not limited to, ROM firmware 13 and CAM 39. In system 12, an alternative to using an opcode in vector 33 can be to form an opcode from the concatenation of bits from vector 33 with bits from the match identification 41. In this embodiment, certain bits from vector 33, for example, bits 15-4, can be used to form opcode template 45. Opcode template 45 can be concatenated with bits forming CAM opcode 47 to complete opcode 46. For example, if opcode 46 is 16 bits wide, bits 3-0 of match identification 41 can be concatenated with opcode template 45 to form opcode 46. If, for example, opcode template 45 is a jump-type opcode, CAM opcode 47 can indicate the location to which the jump is destined. To enable execution flow redirection in this way, vector 33, CAM 39, opcode template 45, and the appropriate at least one enable bit 31 can be initialized without the involvement of CPU 52 through serial interface 51, for example.

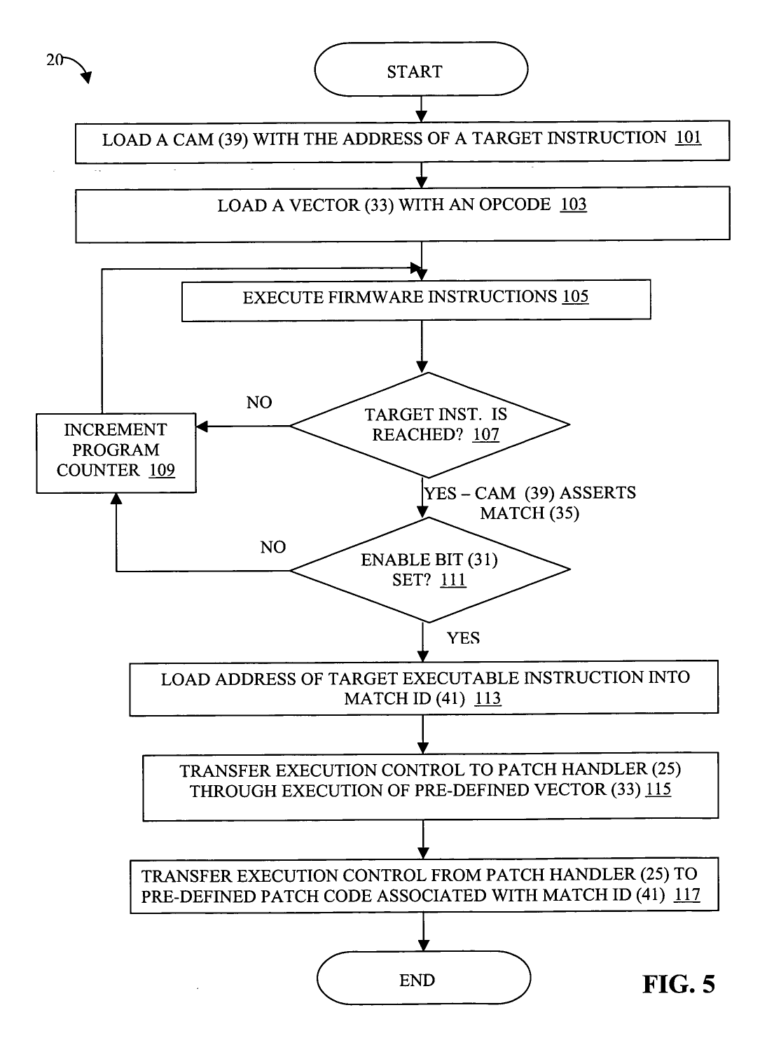

Referring now to FIG. 5, method 20 of the present invention is set forth in flowchart fashion and can include, but is not limited to, the steps of loading a CAM 39 with at least one address corresponding to at least one target executable instruction in firmware 13 (method step 101), loading a vector 33 with an opcode (method step 103), and executing firmware 13 instructions (method step 105). If the at least one target executable instruction is not attained (decision step 107), method 20 can include the steps of incrementing the program counter (method step 109) and resuming execution of the firmware 13 instructions (method step 105). If the at least one target executable instruction is attained (decision step 107), and if an appropriate at least one enable bit 31, indicating that execution control is to be transferred, is not set (decision step 111), method 20 can include the steps of incrementing the program counter (method step 109) and resuming execution of the firmware 13 instructions (method step 105). If the at least one target executable instruction is attained (decision step 107), and if the appropriate at least one enable bit 31 is set (decision step 111), method 20 can include the steps of loading the CAM 39 address of the target executable instruction into a match identification 41 (FIG. 3) (method step 113) and transferring execution control to a patch handler 25 (FIG. 1) through execution of a pre-defined vector 33 (method step 115). Method 20 can further include the step of transferring execution control from patch handler 25 to pre-defined patch code associated with the match identification 41 (method step 117).

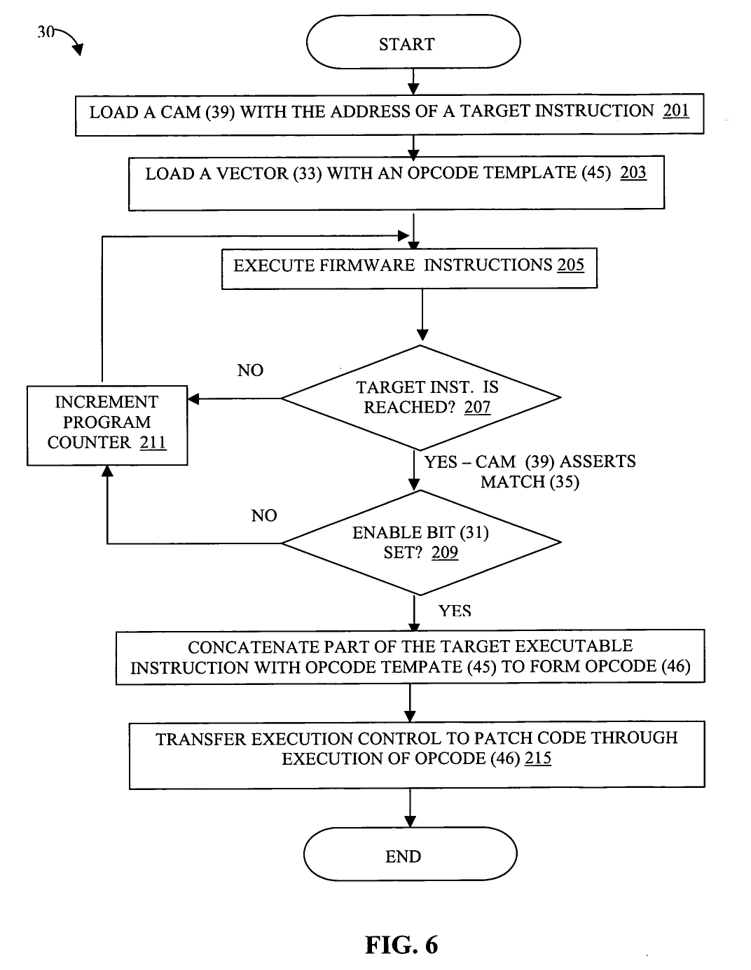

Referring now to FIG. 6, method 30, an alternate method of the present invention is set forth in flowchart fashion and can include, but is not limited to, the steps of loading a CAM 39 with at least one address corresponding to at least one target executable instruction in firmware 13 (method step 201), loading a vector 33 with an opcode template 45 (FIG. 4) (method step 203), and executing firmware 13 instructions (method step 205). If the at least one target executable instruction is not attained (decision step 207), method 30 can include the steps of incrementing the program counter (method step 211) and resuming execution of the firmware 13 instructions (method step 205). If the at least one target executable instruction is attained (decision step 207), and if the appropriate at least one enable bit 31, indicating that execution control is to be transferred, is not set (decision step 209), method 30 can include the steps of incrementing the program counter (method step 211) and resuming execution of the firmware 13 instructions (method step 205). If at least one target executable instruction is attained (decision step 207), and if the appropriate at least one enable bit 31 is set (decision step 209), method 30 can include the steps of concatenating part of the target executable instruction with opcode template 45 to form opcode 46 (FIG. 4) (method step 213) and transferring execution control to patch code through execution of opcode 46 (method step 215).

Although the invention has been described with respect to various embodiments and methods, it should be realized that this invention is also capable of a wide variety of further and other embodiments and methods within the spirit and scope of the appended claims.

What is claimed is:

1. A system for modifying execution control in firmware comprising:
firmware having at least one target executable instruction;
computer registers capable of storing a vector, at least one enable bit, and a match identification, said vector capable of transferring execution control to a patch handler, said at least one enable bit capable of storing associated with said at least one target executable instruction;
a content addressable memory (CAM) capable of asserting a match when said at least one target executable instruction is attained; and
circuitry capable of loading said match identification with a matching said at least one target executable instruction when said CAM asserts said match and when said at least one enable bit is set, said circuitry further capable of transferring execution control through said vector to said patch handler if said CAM asserts said match and said at least one enable bit is set;
wherein said patch handler is capable of transferring execution control to patch code associated with said match identification, and wherein execution control in firmware is modified.

2. The system as defined in claim 1 further comprising:
a means for loading the contents of said CAM, said vector, and said at least one enable bit.

3. The system as defined in claim 2 wherein said means for loading comprises:
a serial interface electrically coupled with said CAM, said vector, and said at least one enable bit.

4. A system for modifying execution control in firmware comprising:
firmware having at least one target executable instruction;
computer registers capable of storing an opcode template and at least one enable bit associated with said at least one target executable instruction;
a content addressable memory (CAM) capable of asserting a match when said at least one target executable instruction is attained, said CAM capable of emitting a match identification when said match is asserted; and
circuitry capable of concatenating said opcode template with a part of said match identification to form an opcode, said circuitry further capable of transferring execution control to said patch code through said opcode when said CAM asserts said match and when said at least one enable bit is set.

5. The system as defined in claim 4 further comprising:
a means for the contents of said CAM, said opcode template, and said at least one enable bit.

6. The system as defined in claim 5 wherein said means for loading comprises:
a serial interface electrically coupled with said CAM, said vector, and said at least one enable bit.

7. A method for modifying execution control in firmware comprising the steps of:
loading a content addressable memory (CAM) with at least one address corresponding to at least one target executable instruction in firmware;
loading a vector with an opcode;
executing firmware instructions until the at least one target executable instruction is attained;
testing at least one enable bit;
loading the address of the at least one target executable instruction into a match identification;
transferring execution control to a patch handler through the vector; and
transferring execution control from the patch handler to pre-defined patch code associated with the match identification.

8. The method as defined in claim 7 further comprising the step of:
loading the at least one enable bit, the CAM, and the vector.

9. The method as defined in claim 7 further comprising the steps of:
connecting a serial interface to the at least one enable bit, the CAM, and the vector; and
loading the at least one enable bit, the CAM, and the vector using the serial interface.

10. A method for modifying execution control in firmware comprising the steps of:
loading a content addressable memory (CAM) with at least one address of at least one target executable instruction;
loading an opcode template;
executing firmware instructions until the at least one target executable instruction is attained;
testing at least one enable bit;
concatenating part of the at least one target executable instruction with the opcode template to form an opcode; and
transferring execution control to pre-defined patch code through execution of the opcode if a match is asserted in the CAM and if the at least one enable bit is set.

11. The method as defined in claim 10 further comprising the steps of:
loading the CAM, the at least one enable bit, and the opcode template.

12. The method as defined in claim 10 further comprising the steps of:
connecting a serial interface to the CAM, the at least one enable bit, and the opcode template; and
loading the CAM, the at least one enable bit, and the opcode template through the serial interface.
